(19) United States
(12) Patent Application Publication
(10) Pub. No.: US 2003/0210812 A1
(43) Pub. Date: Nov. 13, 2003

(54) Apparatus and method for surgical navigation

(76) Inventors: Ali Khamene, Plainsboro, NJ (US); Frank Sauer, Princeton, NJ (US); Sebastian Vogt, Princeton, NJ (US)

Correspondence Address: Siemens Corporation, Intellectual Property Department, 170 Wood Avenue South, Iselin, NJ, 08830, US

(21) Appl. No.: 10/373,442

(22) Filed: Feb. 25, 2003

Related U.S. Application Data
(60) Provisional application No. 60/359,888, filed on Feb. 26, 2002.

(51) Int. Cl. G06K 9/00

(52) U.S. Cl. 382/128; 382/103

(57) ABSTRACT

An apparatus for pose determination using single camera tracking in a workspace includes a computer programmed for making the pose determination and a tracker camera coupled to the computer for providing a tracking image and for which calibration information is stored. A plurality of marker bodies bears markers adapted for attachment to respective objects to be tracked, the markers exhibiting characteristics for providing respective images of themselves in the tracking image, such that the respective images provide sufficient information in the tracking image for respective pose determination for each of the objects in conjunction with the calibration information.

### CROSS-REFERENCE TO RELATED APPLICATIONS

Reference is hereby made to copending U.S. Provisional Patent Application No. 60/359,888, filed Feb. 26, 2002 in the names of inventors Ali Khamene, Frank Sauer, and Sebastian Vogt, entitled METHOD AND APPARATUS FOR SURGICAL NAVIGATION, and whereof the disclosure is hereby incorporated by reference herein and whereof the benefit of priority is claimed.

It is noted that the said Provisional patent application incorporates by reference the disclosure of the following patent applications to which reference is hereby made and whereof the disclosure is incorporated herein by reference:

application Ser. No. 10/222,182;

application Ser. No. 10/222,308; and

application Ser. No. 09/953,679.

### BACKGROUND OF THE INVENTION

The present invention relates to the field of surgical navigation and, more specifically, to tracking for surgical navigation.

### FIELD OF THE INVENTION

Surgical navigation is commonly utilized to help a surgeon or an interventional radiologist to guide instruments such as, for example, a biopsy needle to a particular target inside a medical patient's body that was identified on one or more medical images, such as an image obtained by computerized tomography (CT) or by magnetic resonance imaging (MRI) or other appropriate technique.

Navigation systems are available that comprise tracking systems to keep track of the positions of the instruments. These tracking systems are generally based either on optical or electromagnetic principles. Commercial optical tracking systems typically employ rigid multi-camera constellations, a popular type being stereo camera systems such as, for example, the Polaris® from the Northern Digital company.

These tracking systems work essentially by locating markers in each camera image, and then calculating the marker locations in 3D space by triangulation. For instrument tracking, “rigid body” marker sets with known geometric configurations are attached to the instruments. From the 3D marker locations, the system calculates the pose (rotation and translation) of the marker body with respect to a relevant coordinate system. Prior calibration and registration enable the system to derive the pose of the instrument from the pose of the marker body, and reference it to the patient's medical images. These procedures are commonly known to those versed in the art.

The afore-mentioned application No. 60/312,876 discloses a method for local 3-dimensional (3D) reconstruction from 2-dimensional (2D) ultrasound images which includes deriving a 2D image of an object; defining a target region within said 2D image; defining a volume scan period; during the volume scan period, deriving further 2D images of the target region and storing respective pose information for the further 2D images; and reconstructing a 3D image representation for the target region by utilizing the 2D images and the respective pose information.

The afore-mentioned application No. 60/312,872 discloses a method for marking three-dimensional (3D) locations from images obtained from an ultrasound imaging system including a transducer. The method comprises the steps of: tracking the pose of the transducer with respect to an external 3D coordinate system; obtaining a two-dimensional (2D) ultrasound image from the transducer; marking a desired target with a marker on the 2D ultrasound image; and calculating the 3D position of the marker utilizing data from the step of tracking.

### BRIEF SUMMARY OF THE INVENTION

The present invention discloses a different approach to optical tracking for surgical navigation or for other applications such as tracking in an industrial work area. In accordance with an aspect of the present invention, a tracking system employs a camera that is “self-sufficient”, that is, the system can, from the images of this single camera alone, derive the pose information required for the mapping between various objects associated with marker bodies, such as, for example, an instrument and a patient. Pose information is to be understood to mean complete pose information, including object position and orientation.

In the context of the present invention, tracking is generally concerned with different coordinate systems, such as an image space coordinate system, a workspace coordinate system, a camera coordinate system, an instrument coordinate system. Except for the camera and image coordinate system, these coordinate systems are physically defined by the use of respective associated marker sets. In a registration procedure, it is required to determine where objects are in their respective coordinate systems. For example, where a biopsy needle is with respect to the “needle coordinate system” represented by the respective attached marker set, and how the image coordinate system is related to a patient or workspace coordinate system or an imager coordinate system such as, for example, an ultrasound transducer coordinate system. Tracking thus establishes relationships between coordinate systems that can be changing, and keeps track of them over time. By way of an example, a single tracker camera, with pre-determined internal camera parameters, “sees” the work space marker set and the instrument marker set. The evaluation process calculates the pose of workspace and instrument coordinate systems with respect to the camera coordinate system, and deduces the pose of the instrument coordinate system and, accordingly, the pose of the instrument with respect to the workspace coordinate system.

As used herein, the term “tracker camera” in one sense primarily means a video type camera, including visible light or infrared sensitive, wide-angle field of view, light-emitting diode (LED) illuminator equipped cameras, which provides an input for calculating the pose of a tracked marker set. In this sense, calibration for the camera need not be qualified specifically as applicable to a specific space, such as a medical image space. Internal camera parameters that have been determined in a previous camera calibration step characterize the camera independently of the medical image space. This is distinguishable from another, commonly understood sense, where the term “tracker camera” is sometimes used to mean the whole tracking system, as in determining the pose of an object “using a tracker camera”, whereas the tracking system actually employs the actual camera only as a sensing device and additionally requires a computer with appropriated software for making the pose calculation. The calculation depends on camera calibration data and other calibration data such as the geometry of marker sets, registration information, and so forth.

In accordance with an aspect of the invention, apparatus for pose determination in surgical navigation using single camera tracking comprises a computer programmed for making a pose determination; a tracker camera coupled to the computer for providing thereto a tracking image and whereof calibration information is stored in the computer; at least one marker body bearing markers and being adapted for attachment to at least one respective instrument to be tracked; at least one further marker body bearing markers and being adapted for attachment to at least one respective object to be tracked; and the markers exhibiting characteristics for providing respective images thereof in the tracking image such that the respective images provide sufficient information in the tracking image for enabling the computer to make respective pose determinations for each of the at least one respective instrument and the at least one respective object, in conjunction with the calibration information.

In accordance with another aspect of the invention, apparatus for pose determination in surgical navigation using single camera tracking comprises a computer programmed for making a pose determination; a tracker camera coupled to the computer for providing thereto a tracking image and whereof calibration information is stored in the computer; at least one marker body bearing markers and being adapted for attachment to at least one respective instrument to be tracked; a plurality of marker bodies bearing markers and being adapted for attachment to respective objects to be tracked; and the markers exhibiting characteristics for providing respective images thereof in the tracking image such that the respective images provide sufficient information in the tracking image for enabling the computer to make respective pose determinations for each of the at least one respective instrument and for each of the respective objects, in conjunction with the calibration information.

In accordance with another aspect of the invention, apparatus for pose determination comprises a computer programmed for finding the respective images of the markers appearing in the tracking image by, for each marker body and markers associated therewith: determining 2D coordinates of centers of the markers, from the respective images, calculating the center of distribution of the markers by averaging over the centers of the markers, identifying the closest individual marker to this center of distribution and designating it as the central marker of the marker body, finding a largest marker in the image and designating it as the largest marker of the marker body, and starting at the largest marker, moving around the center of distribution in angular rotation fashion and labeling markers accordingly.

In accordance with another aspect of the invention, apparatus for pose determination for surgical navigation using single camera tracking comprises a computer programmed for making a pose determination; a tracker camera coupled to the computer for providing thereto a tracking image and whereof calibration information is stored in the computer; at least one marker body bearing markers and being adapted for attachment to at least one respective instrument to be tracked; at least one further marker body bearing markers and being adapted for attachment to at least one respective object to be tracked; and the markers exhibiting characteristics for providing respective images thereof in the tracking image such that the respective images provide sufficient information in the tracking image for enabling the computer to make respective pose determinations for each of the at least one respective instrument and the at least one respective object, in conjunction with the calibration information by the computer being programmed for finding the respective images of the markers appearing in the tracking image.

In accordance with another aspect of the invention, a method for pose determination for pose determination navigation using single camera tracking, comprises the steps of obtaining a tracking image for a medical image space from a tracker camera; providing calibration information for the camera in the medical image space; attaching an arrangement of a plurality of markers to at least one marker body adapted for attachment to an instrument to be tracked; attaching at least one further marker body bearing markers and being adapted for attachment to at least one respective object to be tracked; and arranging the markers for exhibiting characteristics for providing respective images thereof in the tracking image such that the respective images provide sufficient information in the tracking image for enabling the computer to make respective pose determinations for each of the at least one respective instrument and the at least one respective object, in conjunction with the calibration information by the computer being programmed for finding the respective images of the markers appearing in the tracking image.

In accordance with another aspect of the invention, apparatus for pose determination comprises a marker body, for use with a tracker camera for providing an image for single camera tracking, the marker body being adapted for attachment to an object to be tracked, comprising: an arrangement of a plurality of markers attached to the marker body; and wherein the markers are disposed on the marker body in a 3-dimensional (3D) configuration, whereby a subset of the markers are “high” and others are “low”.

In accordance with another aspect of the invention, apparatus for pose determination using single camera tracking in a workspace, comprises: a plurality of tracking modalities, including at least one tracker camera for providing a tracking image for a medical image space; a computer programmed for making a pose determination; the tracker camera being coupled to the computer for providing thereto a tracking image and whereof calibration information is stored in the computer; at least one marker body bearing markers and being adapted for attachment to at least one respective instrument to be tracked; at least one further marker body bearing markers and being adapted for attachment to at least one respective object to be tracked; and the markers exhibiting characteristics for providing respective images thereof in the tracking image such that the respective images provide sufficient information in the tracking image for enabling the computer to make respective pose determinations for each of the at least one respective instrument and the at least one respective object, in conjunction with the calibration information.

In accordance with another aspect of the invention, apparatus for pose determination using single camera tracking in a workspace includes a computer programmed for making the pose determination and a tracker camera coupled to the computer for providing a tracking image and for which calibration information is stored. A plurality of marker bodies bears markers adapted for attachment to respective objects to be tracked, the markers exhibiting characteristics for providing respective images of themselves in the tracking image, such that the respective images provide sufficient information in the tracking image for respective pose determination for each of the objects in conjunction with the calibration information.

### BRIEF DESCRIPTION OF THE DRAWING

The invention will be more fully understood from the following detailed description, in conjunction with the Drawing, of which

FIG. 1 shows a block diagram of a system in accordance with the principles of the invention; and

FIG. 2 shows a biopsy needle with a marker body attached, for optical tracking in accordance with the principles of the present invention.

### DETAILED DESCRIPTION OF THE INVENTION

In applicant's aforementioned patent application Ser. No. 09/953,679 entitled “Video-see-through Head-mounted Display with integrated optical tracking”, a system is described wherein a single head-mounted camera is used to keep track of a user's head position with respect to a frame of markers around a workspace. See also an article entitled AUGMENTED WORKSPACE: DESIGNING AN AR TESTBED, authored by Frank Sauer et al, an inventor in the present application, and published on pages 47-53 of the Proceedings of the IEEE and ACM International Symposium on Augmented Reality 2000, dated Oct. 5-6, 2000; Munich, Germany; IEEE Computer Society, Los Alamitos, Calif., U.S.A.

The afore-mentioned article describes a tabletop setup to explore Augmented Reality visualization, referred to as an “augmented workspace”. The user sits at the table and performs a manual task, guided by computer graphics overlaid onto his view. The user wears a custom video-see-through head mounted display (HMD). Two color video cameras attached to the HMD provide a stereo view of the scene, and a third video camera is added for tracking.

A paper beginning on page 111 of the above-cited Proceedings of the IEEE for 2000 entitled “Virtual Object Manipulation on a Table-Top AR environment” by Kato et al. is of especial interest relative to the present invention. These Proceedings also provide other related material helpful as background to a fuller understanding of the field of the present invention.

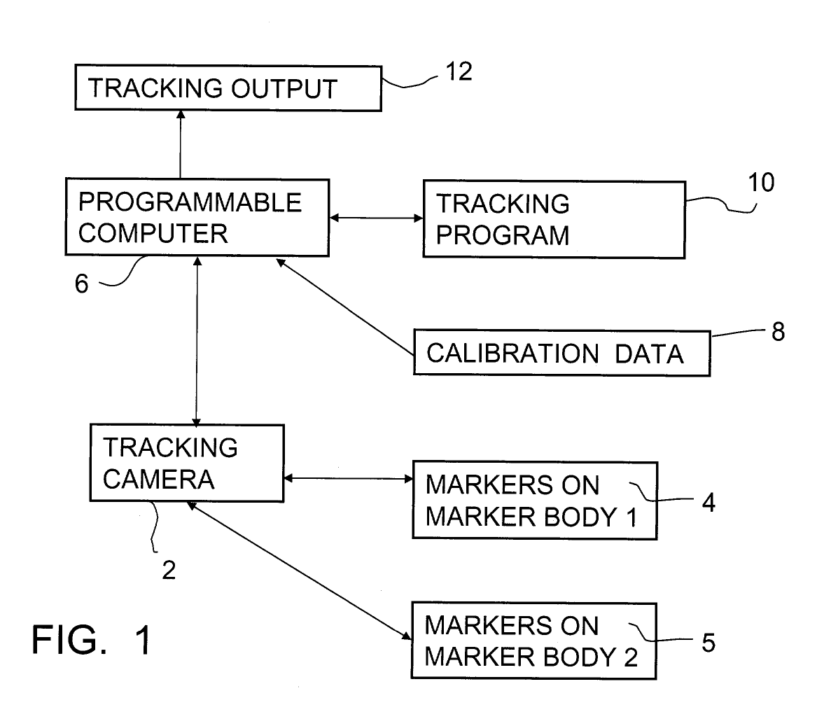

FIG. 1 shows a system in accordance with the principles of the invention. A tracking camera 2, as used herein for providing single camera tracking provides image information of an image space including markers 4 on a first marker body and markers 5 on a second marker body, as will hereinafter be explained in detail. Camera 2 provides image information to a computer 6, such as a programmable digital computer which also receives calibration data 8 relating to camera parameters and the geometry of the marker configuration. Computer 6 utilizes a tracking program 10 to derive a tracking information output 12, utilizing image information from camera 2 and calibration data 8.

As used herein, the term “single-camera tracking” defines a system wherein a single tracking camera provides all of the information needed to track a first object, such as an instrument, with a marker arrangement attached thereto, and at least one further object, such as another instrument, such as a patient's body or, in another setting, an industrial object, with a further marker arrangement attached thereto also exhibiting the property of providing all the information to track the further object and distinguish it from the first object, using the information in its tracking image. It will be understood that, while FIG. 1 shows first and second marker bodies, each adapted for being attached to a respective object, additional objects with appurtenant respective marker bodies can be tracked using the single tracking camera in accordance with the principles of the present invention. A suitable algorithm is then utilized to extract the tracking data from this information in conjunction with predetermined calibration information. As herein recognized, such calibration information takes account of internal parameters for the tracking camera and the geometry of the respective marker arrangements. An exemplary algorithm for accomplishing this task will be hereinafter described; however, other algorithms can be used to provide analogous results. As will be understood, such single-camera tracking can be utilized in conjunction with other cameras, or other imaging devices where the other devices may, but need not, themselves operate in the single-camera tracking mode. Furthermore, single-camera tracking may be utilized in conjunction with known systems of augmented reality such as have been otherwise utilized in industrial, medical, and other environments.

Markers as herein used and as, per se, known in the field of use of the present invention, are typically retro-reflectors, either planar and preferably of circular form or spherically shaped. Such passive devices may also include fluorescent materials. A source of illumination is required for such passive markers, including catoptrical devices, to render them visible in a camera image and such illumination source, or illuminator, may be conveniently attached to the tracking camera, it being necessary that a light source for a retro-reflector need be close to the camera for the camera to receive the reflected light. Markers may also be actively light-emitting, such as, preferably light emitting devices (LED's), or miniature incandescent bulbs such as “grain o' wheat” bulbs. As herein recognized, such active devices may be operated continuously and/or utilize pulse or other time coding, intensity or wavelength modulation, for identification. Markers, whether active or passive may also utilize characteristics such as fluorescence and/or distinctive color and/or shape codes for identification.

In accordance with principles of the present invention, the concept of single-camera tracking is also extended to instrument tracking. A rigid body of markers suitable for single-camera tracking is attached to the instrument to be tracked. This marker body is different from a frame of markers that is preferably used for head tracking with respect to a workspace, and it is different from a marker body that is used for tracking with a stereo camera (or multi-camera) system. For the preferred pose algorithm, as disclosed in a publication by Roger Tsai, one needs the marker body to contain at least 7 markers. See Roger Y. Tsai, “A versatile Camera Calibration Technique for High-Accuracy 3D Machine Vision Metrology Using Off-the-Shelf TV Cameras and Lenses”, IEEE Journal of Robotics and Automation, Vol. RA-3, No.4. August 1987, pages 323-344.

More markers can be used to make the result numerically more stable and to reduce noise in the pose result.

In contrast, as herein recognized, a stereo-camera tracking system can determine the pose of the rigid marker body based on only three markers. Hence, a stereo-camera system can do with a simpler marker configuration, but at the expense of requiring an extra tracking camera.

In accordance with the principles of the present invention, an optimal way of designing marker bodies for a single camera tracking system is disclosed. The larger the extent of the marker body in the tracker camera's image, the more precise will be the result of the pose determination; however, smaller marker bodies provide a more elegant and practicable solution.

While good pose results are obtainable for large marker bodies even when the individual markers are coplanar, a 3-dimensional (3D) configuration of the markers becomes essential when the marker bodies are small. For a given lateral extent of the marker body, there is then a trade-off between the extent of its depth and the range of viewing angles for which the markers are seen as separate entities in the tracker camera's image.

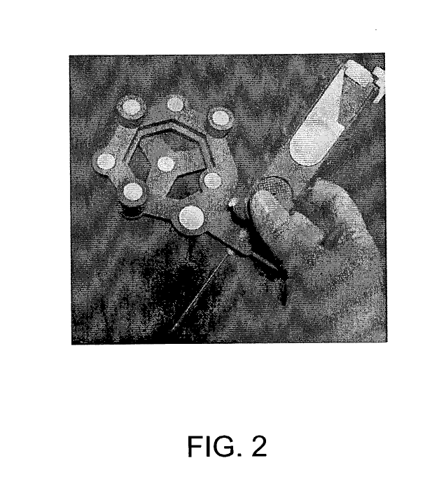

In accordance with the principles of the present invention, an optimal way to establish a 3D configuration of the markers is to place them in a multilevel planar arrangement, as shown in the FIG. 2, in which a biopsy needle is shown with a multilevel-planar marker body attached. In the exemplary embodiment shown, the markers are retroreflective disks and are arranged on four depth levels. “High” and “low” markers are preferably arranged in alternating fashion in neighboring positions. In accordance with an alternative aspect of the present in invention, most of the markers are placed, as a design consideration, on the periphery of the marker body, preferably in a circular fashion, with one in the center of the marker body. For identifying the individual markers in the tracker camera's image, the exemplary marker body in the Figure contains one marker that is larger than the others.

The identification algorithm then works in the following manner:

find all the markers in the tracker camera image and determine the 2D coordinates of their centers in the image, in accordance with procedures known in the art;

calculate the center or centroid of the marker distribution by averaging over all the marker centers;

identify the closest marker to this center as the central marker of the marker body;

find the largest marker in the image;

identify as such the largest marker of the marker body; and

starting at the largest marker, move around the center in angular rotation fashion and label the markers accordingly.

Taking the position of the tracking camera into account, the marker body is preferably attached to the instrument in such a way that it faces the tracking camera when the instrument is being held in the preferred, most convenient, or most comfortable position.

By way of using an example to further illustrate features of the present invention, consider first the system described in the article by F. Sauer et al. entitled “Augmented Reality Visualization of Ultrasound Images: System Description, Calibration, and Features,” IEEE and ACM Int. Symposium On Augmented Reality—ISAR 2001. New York, N.Y., Oct. 29-30, 2001, pages 30-39. The system is also described in more detail in the aforementioned patent applications Nos. 60/312,876 and 60/312,872.

The system described in the foregoing article employs a single head-mounted tracking camera in conjunction with a marker body attached to an ultrasound transducer. Optionally, an additional marker body attached to a patient or to a workspace is used to obtain 3D information relating to an ultrasound transducer, and hence of an ultrasound image, by way of a transformation determined in an initial calibration procedure with respect stationary workspace coordinate system. See the above-mentioned article in ISAR 2001 and in the aforementioned patent applications Nos. 60/312,876 and 60/312,872. This information allows one to build up 3D ultrasound data. The present invention allows the introduction of further tracked instruments, such as a biopsy needle, for example, while still tracking with a single camera.

The system in accordance with the principles of the present invention comprises computing apparatus for a user interface, tracking and visualization. This also provides for medical images and additional graphics, including graphics that shows graphical representations of tracked instruments or graphics related to the position and/or orientation of tracked instruments. The system further includes a display apparatus and at least one video camera. In a preferred embodiment, the video camera may operate selectively or exclusively in the spectrum of the near infrared wavelengths. The system further includes marker equipment or devices attachable to instrument and/or tools, including passive devices, such as retroreflective devices and/or active marker devices such as light emitting diodes (LED's) and, at least in the event of use of passive or reflective devices, a light source or sources for illumination.

In a system in accordance with the principles of the present invention, the camera may be rigidly mounted. The rigidly mounted camera is utilized in conjunction with a set of markers defining a “medical image” space. This medical image space may be a patient space onto which medical images have been registered, the patient being “equipped” with markers, or being fixed with respect to a set of marker or, the medical image space may be defined by a pose of a real-time imaging instrument such as, for example, an ultrasound transducer.

Alternatively, in accordance with the principles of the present invention, the camera may be head-mounted, in conjunction with a set of markers defining a “medical image” space. This medical image space may be a patient space onto which medical images have been registered, the patient being “equipped” with markers, or being fixed with respect to a set of markers or, the medical image space may be defined by a pose of a real-time imaging instrument such as, for example, an ultrasound transducer.

In an alternate embodiment in accordance with the principles of the present invention, the camera may be head-mounted and operated in conjunction with augmented reality visualization as set forth in the aforementioned patent application Ser. No. 09/953,679 and the article in ISAR 2000.

The display in accordance with the present invention may be a head-mounted display or an external monitor may be used.

The instruments to be tracked cover a wide range of devices. For example, such devices include needles, as indicated in the aforementioned article in ISAR 2000, or drills, rigid endoscopes, an ultrasound transducer and so forth, as indicated in the aforementioned article in ISAR 2001.

In another embodiment in accordance with the principles of the present invention, multiple cameras are utilized so as to achieve better robustness against blocking the line of sight, and/or to cover a larger field of view, with the cameras respectively tracking different marker bodies that are too far apart to be seen by single camera. Optionally, multiple or plural cameras are utilized for achieving higher precision. In a preferred embodiment of the present invention, at least one set of markers that is being tracked is designed for single camera tracking, and single camera tracking evaluation is part of the pose determination algorithm, performed on the images of at least one of the multiple cameras.

In accordance with another embodiment of the present invention, single-camera tracking is combined with either or both of a stereo-camera tracking system and a magnetic tracking system.

It is also contemplated to use a rigid marker body with a non-coplanar marker distribution, utilizing a multilevel design, preferably made as a single part. Such a marker body is advantageously made of a suitable plastic material such that the design is both lightweight and cheap. In a preferred embodiment, the marker comprises a disk shape which is utilized advantageously for the passive marker embodiments and, being both easily and inexpensively fabricated, allow markers to be spread out to allow a larger angular range within which markers appear separately in the tracker camera view.

The markers are advantageously attached to the applicable instrument in a pose that looks towards or faces the tracker camera when instrument is held comfortably and/or conveniently.

In still another embodiment in accordance with the present invention, the angle range for tracking is increased by combining several multilevel planes, angled with respect to each other.

The invention has been described by way of exemplary embodiments. As will be understood by one of skill in the art to which the present invention pertains, various changes and modifications will be apparent. Such changes and substitutions which do not depart from the spirit of the invention are contemplated to be within the scope of the invention which is defined by the claims following.

What is claimed is:

1. Apparatus for pose determination in surgical navigation using single camera tracking, said apparatus comprising:
a computer programmed for making a pose determination;
a tracker camera coupled to said computer for providing thereto a tracking image and whereof calibration information is stored in said computer;
at least one marker body bearing markers and being adapted for attachment to at least one respective instrument to be tracked;
at least one further marker body bearing markers and being adapted for attachment to at least one respective object to be tracked; and
said markers exhibiting characteristics for providing respective images thereof in said tracking image such that said respective images provide sufficient information in said tracking image for enabling said computer to make respective pose determinations for each of said at least one respective instrument and said at least one respective object, in conjunction with said calibration information.

2. Apparatus for pose determination in surgical navigation using single camera tracking, said apparatus comprising:
a computer programmed for making a pose determination;
a tracker camera coupled to said computer for providing thereto a tracking image and whereof calibration information is stored in said computer;
at least one marker body bearing markers and being adapted for attachment to at least one respective instrument to be tracked;
a plurality of marker bodies bearing markers and being adapted for attachment to respective objects to be tracked; and
said markers exhibiting characteristics for providing respective images thereof in said tracking image such that said respective images provide sufficient information in said tracking image for enabling said computer to make respective pose determinations for each of said at least one respective instrument and for each of said respective objects, in conjunction with said calibration information.

3. Apparatus for pose determination as recited in claim 1, wherein said marker bodies are organized such that said respective images thereof are identifiable in said tracking image.

4. Apparatus for pose determination as recited in claim 1, wherein said computer provides data processing functions including identifying said respective images in said tracking image.

5. Apparatus for pose determination as recited in claim 1, wherein markers are respectively disposed on said marker bodies in a 3-dimensional (3D) configuration, whereby a subset of said markers are “high” and others are “low”.

6. Apparatus for pose determination as recited in claim 5 wherein markers are respectively disposed on said marker bodies such that at high and low markers are arranged in alternating fashion.

7. Apparatus for pose determination as recited in claim 1, wherein markers are respectively situated on the periphery of said marker bodies.

8. Apparatus for pose determination as recited in claim 7, wherein markers are respectively disposed on marker bodies in a generally circular fashion.

9. Apparatus for pose determination as recited in claim 8, wherein one marker is situated proximate the center of markers respectively disposed in a generally circular fashion.

10. Apparatus for pose determination as recited in claim 1, wherein at least one marker of said markers is larger than others.

11. Apparatus for pose determination as recited in claim 4, wherein said markers are arranged so as to tend to increase the range of viewing angles for which markers appear as separate entities in said tracking image.

12. Apparatus for pose determination as recited in claim 5, wherein said markers are arranged so as to maximize the range of viewing angles for which markers appear as separate entities in said tracking image.

13. Apparatus for pose determination as recited in claim 4, wherein said markers include a retro-reflector marker.

14. Apparatus for pose determination as recited in claim 4, wherein said markers include a light-emitting diode (LED) marker.

15. Apparatus for pose determination as recited in claim 4, wherein said markers include a light-emitting diode (LED) marker exhibiting time-modulated emission of light.

16 Apparatus for pose determination recited in claim 1, wherein said markers include a color-coded marker.

17. Apparatus for pose determination recited in claim 4, wherein said markers include a shape-coded marker.

18. Apparatus for pose determination as recited in claim 1, wherein said at least one marker body is adapted for attachment to said instrument to be tracked such that, taking account of tracking camera position, said at least one marker body faces said tracking camera when said instrument is being held in a preferred position.

19. Apparatus for pose determination as recited in claim 1, wherein said marker bodies comprise a rigid marker body with a non-coplanar marker distribution exhibiting a multilevel design.

20. Apparatus for pose determination as recited in claim 19, wherein said marker body comprises a plurality of multilevel planes.

21. Apparatus for pose determination as recited in claim 20, wherein said multilevel planes are angled with respect to each other.

22. Apparatus for pose determination as recited in claim 2, wherein said marker bodies are of unitary construction.

23. Apparatus for pose determination as recited in claim 2, wherein said tracker camera is adapted for head mounting on a user's head.

24. Apparatus for work space navigation as recited in claim 2, wherein said tracker camera is operated in conjunction with augmented reality visualization apparatus.

25. Apparatus for pose determination as recited in claim 1, wherein said computer is programmed for finding said respective images of said markers appearing in said tracking image by, for each marker body and markers associated therewith: determining 2D coordinates of centers of said markers, from said respective images, calculating the center of distribution of said markers by averaging over said centers of said markers, identifying the closest individual marker to this center of distribution and designating it as the central marker of said marker body, finding a largest marker in the image and designating it as the largest marker of said marker body, and starting at said largest marker, moving around said center of distribution in angular rotation fashion and labeling markers accordingly.

26. Apparatus for pose determination as recited in claim 25, wherein said at least one further marker body is adapted for attachment to the body of a patient in a medical image space.

27. Apparatus for pose determination as recited in claim 25, wherein said tracker camera is operated in conjunction with augmented reality visualization apparatus.

28. Apparatus for pose determination as recited in claim 27, including a head-mounted display coupled to said computer.

29. Apparatus for pose determination as recited in claim 25, including a separate display monitor coupled to said computer.

30. Apparatus for pose determination as recited in claim 26, wherein said medical image space is at least one of
(a) a patient space onto which medical images have been registered and wherein a patient is in fixed relationship with said markers, and
(b) an imaging space of said at least one object wherein said at least one object comprises an imaging device.

31. Apparatus for pose determination for surgical navigation using single camera tracking, said apparatus comprising:
a computer programmed for making a pose determination;
a tracker camera coupled to said computer for providing thereto a tracking image and whereof calibration information is stored in said computer;
at least one marker body bearing markers and being adapted for attachment to at least one respective instrument to be tracked;
at least one further marker body bearing markers and being adapted for attachment to at least one respective object to be tracked; and
said markers exhibiting characteristics for providing respective images thereof in said tracking image such that said respective images provide sufficient information in said tracking image for enabling said computer to make respective pose determinations for each of said at least one respective instrument and said at least one respective object, in conjunction with said calibration information by said computer being programmed for finding said respective images of said markers appearing in said tracking image.

32. Apparatus for pose determination as recited in claim 31, wherein said computer is programmed for finding said respective images of said markers appearing in said tracking image by, for each marker body and markers associated therewith: determining 2D coordinates of centers of said markers, from said respective images, calculating the center of distribution of said markers by averaging over said centers of said markers, identifying the closest individual marker to this center of distribution and designating it as the central marker of said marker body, finding a largest marker in the image and designating it as the largest marker of said marker body, and starting at said largest marker, moving around said center of distribution in angular rotation fashion and labeling markers accordingly.

33. Apparatus for pose determination as recited in claim 31, wherein said at least one further marker body is adapted for attachment to the body of a patient in a medical image space.

34. Apparatus for pose determination as recited in claim 33, wherein said medical image space is at least one of
(a) a patient space onto which medical images have been registered and wherein a patient is in fixed relationship with said markers, and
(b) an imaging space of said at least one object wherein said at least one object comprises an imaging device.

35. Apparatus for pose determination as recited in claim 31, wherein said tracker camera is operated in conjunction with augmented reality visualization apparatus.

36. Apparatus for pose determination as recited in claim 31, including a head-mounted display coupled to said computer.

37. Apparatus for pose determination as recited in claim 31, including a separate display monitor coupled to said computer.

38. Apparatus for pose determination as recited in claim 33, wherein said at least one object comprises an imaging device and wherein said medical image space is at least one of
(a) a patient space onto which medical images have been registered and wherein a patient is in fixed relationship with said markers, and
(b) an imaging space of said imaging device.

39. Apparatus for pose determination for surgical navigation, said apparatus comprising:
a plurality of tracking modalities, said plurality of modalities including tracking apparatus for pose determination in surgical navigation using single camera tracking, wherein said tracking apparatus comprises:
at least one tracker camera for providing a tracking image for a medical image space;
a computer programmed for making a pose determination;
said tracker camera being coupled to said computer for providing thereto a tracking image and whereof calibration information is stored in said computer;
at least one marker body bearing markers and being adapted for attachment to at least one respective instrument to be tracked;
at least one further marker body bearing markers and being adapted for attachment to at least one respective object to be tracked; and
said markers exhibiting characteristics for providing respective images thereof in said tracking image such that said respective images provide sufficient information in said tracking image for enabling said computer to make respective pose determinations for each of said at least one respective instrument and said at least one respective object, in conjunction with said calibration information.

40. Apparatus for pose determination as recited in claim 39, wherein said plurality of tracking modalities includes a plurality of tracker cameras.

41. Apparatus for pose determination as recited in claim 39, wherein said plurality of tracking modalities includes any of a further tracker camera, electromagnetic tracking equipment, mechanical sensing devices, mechanical coupling devices, and acoustic wave tracking equipment.

42. A method for pose determination navigation using single camera tracking, said method comprising the steps of:
obtaining a tracking image for a medical image space from a tracker camera;
providing calibration information for said camera in said medical image space;
attaching an arrangement of a plurality of markers to at least one marker body adapted for attachment to an instrument to be tracked;
attaching at least one further marker body bearing markers and being adapted for attachment to at least one respective object to be tracked; and
arranging said markers for exhibiting characteristics for providing respective images thereof in said tracking image such that said respective images provide sufficient information in said tracking image for enabling said computer to make respective pose determinations for each of said at least one respective instrument and said at least one respective object, in conjunction with said calibration information by said computer being programmed for finding said respective images of said markers appearing in said tracking image.

43. A method for pose determination as recited in claim 42, including the steps of, for each marker body:
determining 2D coordinates of centers of said markers from said respective images;
calculating the center of distribution of markers by averaging over said centers of said markers;
identifying the closest marker to this center of distribution and designating it as the central marker of said marker body;
finding a given marker having predetermined characteristics in said image and designating it as such; and
starting at said given marker, moving around said center of distribution in a defined manner and labeling markers accordingly.

44. A method for pose determination as recited in claim 42, including the step of disposing at least a subset of said markers on a respective marker body in a 3-dimensional (3D) configuration, whereby a subset of said markers are “high” and others are “low”.

45. A method for pose determination as recited in claim 44, including the step of disposing said markers on a respective marker body such that high and low markers are arranged in alternating fashion.

46. A method for pose determination as recited in claim 42, including the step of situating markers on the periphery of a respective marker body.

47. A method for pose determination as recited in claim 42, including the step of disposing markers on a respective marker body in a generally circular fashion.

48. A method for pose determination as recited in claim 47, including the step of disposing one marker proximate the center of said markers disposed in a generally circular fashion.

49. A method for surgical navigation as recited in claim 41, including the step of including one marker on a respective marker body that is larger than others.

50. A method for surgical navigation as recited in claim 44, including the step of arranging said markers so as to tend to increase the range of viewing angles for which markers appear as separate entities in said tracker camera's image.

51. A method for surgical navigation as recited in claim 44, including the step of arranging said markers so as to maximize the range of viewing angles for which markers appear as separate entities in said tracker camera's image.

52. A marker body, for use with a tracker camera for providing an image for single camera tracking, said marker body being adapted for attachment to an object to be tracked, comprising:
an arrangement of a plurality of markers attached to said marker body; and
wherein at least a subset of said markers are disposed on said marker body in a 3-dimensional (3D) configuration, whereby some of said markers are “high” and others are “low”.

53. A marker body as recited in claim 52 wherein said markers are disposed on said marker body such that high and low markers are arranged in alternating fashion in neighboring positions.

54. A marker body as recited in claim 52, wherein markers are situated on the periphery of said marker body.

55. A marker body as recited in claim 52, wherein markers are disposed in a circular fashion.

56. A marker body as recited in claim 52, wherein markers are disposed in a circular fashion with one marker being situated in the center of said marker body.

57. A marker body as recited in claim 52, wherein one marker of said markers is larger than others of said markers.

58. A marker body as recited in claim 52, wherein said markers are arranged so as to tend to increase the range of viewing angles for which markers appear as separate entities in a tracker camera's image.

59. A marker body as recited in claim 52, wherein said markers are arranged so as to maximize the range of viewing angles for which markers appear as separate entities in said tracker camera's image.

60. A marker body as recited in claim 52, wherein said marker body faces said tracking camera when said object is being held in a preferred position.

61. A marker body as recited in claim 52, wherein said marker body comprises a rigid marker body with a non-coplanar marker distribution exhibiting a multilevel design.

62. A marker body as recited in claim 52, including a plurality of multilevel planes, said multilevel planes being angled with respect to each other.

63. A marker body as recited in claim 52, wherein said marker body is of unitary construction.

64. A marker body as recited in claim 52, wherein said markers include a catoptrical device marker.

65. A marker body as recited in claim 52, wherein said markers include a generally spherical marker.

66. A marker body as recited in claim 52, wherein said markers include a marker in the form of a substantially flat disk.

67. A marker body as recited in claim 52, wherein said markers include a retro-reflector marker.

68. A marker body as recited in claim 52, wherein said markers include a light-emitting diode (LED) marker.

69. A marker body as recited in claim 52, wherein said markers include a light-emitting diode (LED) marker exhibiting time-modulated emission of light.

70. A marker body as recited in claim 52, wherein said markers of said marker body include a color-coded marker.

71. A marker body as recited in claim 52, wherein said markers of said marker body include a shape-coded marker.

72. A marker body as recited in claim 52, wherein said object is the body of a patient.

73. Apparatus for pose determination using single camera tracking in a workspace, comprising:
a computer programmed for making said pose determination;
a tracker camera coupled to said computer for providing a tracking image and whereof calibration information is stored in said computer; and
a plurality of marker bodies bearing markers adapted for attachment to respective objects to be tracked, said markers exhibiting characteristics for providing respective images thereof in said tracking image such that said respective images provide sufficient information in said tracking image for respective pose determination for each of said objects in conjunction with said calibration information.

74. Apparatus for pose determination as recited in claim 73, wherein said marker bodies are organized such that said respective images thereof are identifiable in said tracking image.

75. Apparatus for pose determination as recited in claim 74, wherein said computer means provides data processing functions including identifying said respective images in said tracking image.

76. Apparatus for pose determination as recited in claim 73, wherein markers are respectively disposed on said marker bodies in a 3-dimensional (3D) configuration, whereby a subset of said markers are “high” and others are “low”.

77. Apparatus for pose determination as recited in claim 76 wherein markers are respectively disposed on said marker bodies such that high and low markers are arranged in alternating fashion.

78. Apparatus for pose determination as recited in claim 73, wherein markers are respectively situated on the periphery of said marker bodies.

79. Apparatus for pose determination as recited in claim 73, wherein markers are respectively disposed on said marker bodies in a circular fashion.

80. Apparatus for pose determination as recited in claim 73, wherein markers are respectively disposed in a generally circular fashion with one marker being situated in the center.

81. Apparatus for pose determination as recited in claim 73, wherein one marker of said markers is larger than others.

82. Apparatus for pose determination as recited in claim 76, wherein said markers are arranged so as to tend to increase the range of viewing angles for which markers appear as separate entities in said tracking image.

83. Apparatus for pose determination as recited in claim 76, wherein said markers include a retro-reflector marker.

84. Apparatus for pose determination as recited in claim 73, wherein said markers include a light-emitting diode (LED) marker.

85. Apparatus for pose determination as recited in claim 74, wherein said markers include a light-emitting diode (LED) marker exhibiting time-modulated emission of light.

86. Apparatus for pose determination recited in claim 73, wherein said markers include a color-coded marker.

87. Apparatus for pose determination recited in claim 73, wherein said markers include a shape-coded marker.

88. Apparatus for pose determination as recited in claim 73, wherein at least one of said plurality of marker bodies is adapted for attachment to an instrument to be tracked such that, taking account of tracking camera position, said at least one marker faces said tracking camera when said instrument is being held in a preferred position.

89. Apparatus for pose determination as recited in claim 74, wherein said marker bodies comprise a rigid marker body with a non-coplanar marker distribution exhibiting a multilevel design.

90. Apparatus for pose determination as recited in claim 89, wherein at least one of said plurality of marker body comprises a plurality of multilevel planes.

91. Apparatus for pose determination as recited in claim 90, wherein said multilevel planes are angled with respect to each other.

92. Apparatus for pose determination as recited in claim 90, wherein each of said marker bodies bearing respective markers is of unitary construction.

93. Apparatus for pose determination as recited in claim 73, wherein said tracker camera is adapted for head mounting on a user's head.

93. Apparatus for pose determination for in a workspace, said apparatus comprising:
a plurality of tracking modalities, said plurality of modalities including tracking apparatus for pose determination in surgical navigation using single camera tracking, wherein said tracking apparatus comprises:
at least one tracker camera for providing a tracking image for a medical image space;
a computer programmed for making a pose determination;
a plurality of tracking modalities, including at least one tracker camera for providing a tracking image for a medical image space;
a computer programmed for making a pose determination;
said tracker camera being coupled to said computer for providing thereto a tracking image and whereof calibration information is stored in said computer;
at least one marker body bearing markers and being adapted for attachment to at least one respective instrument to be tracked;
at least one further marker body bearing markers and being adapted for attachment to at least one respective object to be tracked; and
said markers exhibiting characteristics for providing respective images thereof in said tracking image such that said respective images provide sufficient information in said tracking image for enabling said computer to make respective pose determinations for each of said at least one respective instrument and said at least one respective object, in conjunction with said calibration information.
